(19) United States
(12) Patent Application Publication
(10) Pub. No.: US 2005/0246160 A1
(43) Pub. Date: Nov. 3, 2005

(54) Information generation system for product formation

(76) Inventor: Johann Ulrich Zimmermann, Neu-Ulm (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/519,085

(22) PCT Filed: Jun. 13, 2003
(86) PCT No.: PCT/EP03/06270

§ 371 Date: Jun. 29, 2005

(30) Foreign Application Priority Data
Jun. 27, 2002 (DE) 10228906.9
Aug. 8, 2002 (DE) 10236384.6

(51) Int. Cl. G06F 17/27

(52) U.S. Cl. 704/9

(57) ABSTRACT

A system for the generation and storage of data, each of which represent a component of a technical product or a step in a formation process for the product. The system can generate types of relationships between several data object types and allocate data object types as well as automatically evaluatable specifications for dependencies between data objects to the types of relationships. A classification for data object types in various phases of the formation process is preferably provided. A coupling together of various applications for separate given phases is without the need to generate and maintain an intermediate model or direct interfaces between the applications.

The present invention relates to a system and an information model for generating information about data objects, each of which represents a component of a technical product or a step in a product formation process.

The term “product formation process” is understood to refer to a sequence of phases and activities that are necessary for manufacturing a technical product. These phases include, for example, design and production planning. The activities of a phase require intermediate results or final results of earlier phases. It is sometimes possible to execute multiple phases in parallel.

Most or all phases of the product formation process for an automotive model series, for example, are supported today by the use of models and automatically analyzable information on data processing systems. A model is a simplified and necessarily incomplete image of a slice of reality, i.e., the product or the product formation process here, on a data processing system. The model contains the properties and the dependencies of reality needed to achieve a certain object of a phase. The term “information” refers to the abstract informational content (the “semantics”) of a statement, description, instruction, message or communication. Data is used to represent and store information in a computer, for example. An information model is a simplification of reality by which information and facts for processing at least one task are structured. A data model describes how the data structured according to an information model is stored physically, e.g., in a data file or a database.

Because specific requirements must often be met in each phase and these requirements differ from one phase to the next and because specific information is sometimes needed to fulfill these requirements, a specific view of the technical product to be developed and manufactured is needed in each phase. The desired approaches will link the models and information of the different phases so that the specific requirements of each phase are met and nevertheless there are no contradictions among the models and there are preferably no redundancies, i.e., multiple instances of identical information. Changes in a model of a phase are ideally tracked in models of another phase.

Modem tools for computer-aided design (CAD) offer the possibility of defining design features or general features, also known as function elements, as components of product models. A design feature is a component of a part and includes geometric definitions, e.g., surfaces, edges, geometric bodies, fillets. Holes, pockets, grooves and ribs on cylinder heads of automotive engines are examples of design features. Features are known from the proposal for the German Industrial Standard DIN 32869-3 “Technical Product Documentation—Three-Dimensional CAD Models—Part 3: Function Elements” of February 2002.

CAD tools, e.g., CATIA or UniGraphics or ProEngineer, frequently offer a library having types of features and functionalities using which a user is able to generate his own types of features (user-defined feature types). The features are often tailored to the specific requirements and terminological universe of a phase. They are the smallest building blocks having functional significance; using these building blocks, a user constructs a product model for a phase and thus implements a specific view of the product. Features represent, for example, holes and cutouts and may be assigned attributes having semantics for the design or manufacturing. Basic geometric features, e.g., lines, circles and squares, are also building blocks that are used in many product models but do not have a functional significance.

Taxonomies (hierarchies of relationship) among types of features are known from T. N. Wong and C. B. Leung: “An object-oriented neutral feature model for feature mapping,” Internat. Journal of Production Research, vol. 38 (2000), pp. 3573-3601. In Wong and Leung, a taxonomy refers to design elements of a phase. The concept of types and exemplars of features corresponds to that of classes and objects (classes and instances, classes and objects) of the object-oriented programming. A taxonomy specifies that a type A is a superclass or parent of a type B. All the properties of type A also apply to type B and thus to all design elements.

To link together models for different phases of the product formation process, different feature transformation approaches have been proposed (feature mapping, feature conversion, feature transformation). The idea behind this is that a set A of features is given for a first phase. By applying a transformation to set A, a set B of features for a second phase is generated. In the general case, n features of set A are mapped on m features of set B, i.e., an n:m mapping is executed.

F. L. Krause, S. Kramer, E. Rieger: “PDGL—a Language for Efficient Feature-Based Product Gestaltung,” Annals of the CIRP, vol. 40, no. 1 (1991), pp. 135-138 and F. L. Krause, A. Ulbrich, F. H. Vosgerau: “Feature-Based Approach for the Integration of Design and Process Planning Systems,” in: J. P. A. M. W. J. Turner (ed.), Proceedings of the 23^{rd} International Symposium on Automotive Technology and Automation, Vienna, December 1990, pp. 140-147: these publications describe a procedure by which the types of features are assigned to knowledge about and specifications for transformation of features (feature mapping knowledge). These publications describe a formal language known as “Part Design Graph Language” (PDGL) for representation of the specifications. The specifications formulated in PDGL are processed by an interpreter of the formal language, for example. The article by J. J. Shah, D. Hsiao, J. Leonard: “A Systematic Approach for Design-Manufacturing Feature Mapping,” in P. R. Wilson, M. J. Wozny, M. J. Pratt (eds.): “Geometric Modeling for Product Realization,” North-Holland Publ., 1992, pp. 205-221 describes automatically executable specifications which are implemented directly via a programming language, namely as part of the processing algorithm of a tool for product design. The specifications define how types of user-defined design features are mapped on previously defined types manufacturing features stored in a library. This mapping is performed using a reconstruction algorithm which implements the transformation outlined above. The algorithm then supplies a “constructive feature tree.”

Approaches for transformation of features based on an intermediate model of the product geometry are described by Y. S. Suh, M. J. Wozny: “Interactive Feature Extraction for a Form Feature-Mapping System,” Rensselaer Polytechnic Institute Troy, N.Y, 1998, and T. N. Wong and C. B. Leung, loc. cit. This intermediate model contains types and examples of intermediate features that are application-neutral. The transformation is performed indirectly via the intermediate model. A product model generated and used for a certain phase is used as a central intermediate model, namely the product model for the phase design (design feature model) in W. F. Bronsvoort, A. Noort, J. van den Berg and G. F. M. Hoek: “Product development with multiple-view feature modeling,” Proceed. FEATS 2001, and in K. J. De Kraker: “Feature Mapping for Concurrent Engineering,” dissertation, Delft University of Technology, 1997. In both publications, features are automatically identified in two steps from the component geometry (feature recognition) and then features are generated for other phases from the design features. Changes in other phases are recognized to a limited extent and automatically result in corresponding changes in the intermediate model. In Wong, loc. cit., application-specific features are generated from features of the neutral intermediate model. Rule-based systems such as those known from “artificial intelligence” are used for this.

A fundamental disadvantage of intermediate models is that only the facts definable in the intermediate model allow description in a phase-specific model. Therefore, the intermediate model must store the information needed in any phase. Therefore, the intermediate model often includes types of “all-purpose features” that are often difficult to handle; saving them results in redundant data management, which is unwanted and requires a large memory capacity.

EP 785491 A2 describes a method and a device for interlinking and managing design information and production information. Relations are established between different items of information and are used to go from one information group to another. Information about products, components and manufacturing steps (processes) is stored in the form of data records, while relations are stored by references between data records. A database scheme is generated for structuring and storing the data records in logical relationships to one another. Automatically analyzable specifications are not mentioned in EP 785491 A2.

DE 19914454 A1 describes a computer-aided system and a method for creating a database. The database to be created includes two basic tables. Elements of a basic class, e.g., data objects of one data object type, are stored in each of these basic tables. Relationships among the elements of the two basic tables may be stored in a relationship table. The database may include multiple relationship tables for the two basic tables. Each relationship of a relationship table is assignable to a relationship category. The relationship categories are stored in a category table.

The basic classes “words,” “persons,” “projects” and “objects” are defined in an exemplary embodiment. A word may be a person's last name. A person may be an inventor of an object defined by a word. A relationship table stores the two relationships “word-person” and “person-word.” “Last name” and “inventor” are stored as relationship categories in the category table and are assigned to the “word-person” and/or “person-word” relationships. A relation table stores all possible relationships among the two basic tables and links them to the entries in the category table. For example, the relationships “person-word,” “object-word,” “project-word” and “object-word” are assigned to the relationship category “name” in the category table through corresponding entries in the relation table.

DE 19816658 A1 describes a relational memory and data processing system. The system includes a memory of the semantic network type having data objects and relations among these data objects. Such a relation may be linked to a data object with the help of a relation relation. Two relations may be linked together by a relation relation.

For example, two data objects C1, C2 for two computer systems of a rocket are each connected to a data object L for a position control system by a “uses” relation. The “uses” relation between C1 and L is linked to a data object for the “normal” operating mode via a “during” relation relation. The “uses” relation between C2 and L is linked to a data object for the “emergency” operating state via a “during” relation relation.

The object of the present invention is to create a system according to the definition of the species of Claim 1 and an information model according to the definition of the species of Claim 13 which do not require an intermediate model and by which the automatically analyzable specifications for dependencies among data objects may be created, expanded, modified, stored and deleted efficiently and without redundancy.

This object is achieved by a system as recited in Claim 1 and by an information model as recited in Claim 13. Advantageous embodiments are characterized in the subclaims.

According to the present invention, in addition to the data objects, which represent components of the product or process, additional data objects are provided, namely relations among data objects and types of such relations. Modular data management is achieved due to the fact that the dependencies among data objects are handled as special data objects that are also type-codable and unwanted redundancy in the data management is reduced. Modular data management in particular results in the specifications being easily created, expanded, modified and deleted.

Data objects for different phases or from different applications are linked by such relations. In particular, these relations connect data objects that represent the same component of the product or process for different phases. Thanks to the relations, it is possible to determine automatically and efficiently which data objects relate to the same component and which additional data objects must be modified after a change in a first data object, so that all the data objects for one component remain consistent with one another. The present invention thus reduces the number and severity of errors in the product formation process, in particular errors based on contradictions between different product models or process models. Changes in individual models are simplified because the automatically executable specifications which determine the consequences of changes and/or automatically execute them are creatable, expandable, modifiable, savable and deletable efficiently and without redundancy.

The relationships are classifiable in types. Therefore, information valid for n similar relations Rel_1, . . . , Rel_n among data objects need not be formulated and saved multiple times. Examples of such information include automatically analyzable specifications, attributes, allowed value ranges, preferred values or standard values (default values) as well as dependencies (constraints) and calculation specifications between attributes of data object types linked by a relation. Instead, one type of relations is generated and it is found that Rel_, . . . , Rel_n are all of this type. Information is assigned to the type and need only be generated and saved once. It is thus valid for Rel_1, . . . , Rel_n.

Not all data objects and all relations are necessarily assigned to one data object type or type of relation. The particular data objects and relations assigned to one type are referred to as “type coded.”

The introduction of relation types allows a simple and uniform access to all relations of one type of relation. For example, an application of the product formation process may assign a new attribute to all relations or it may perform analyses of the attribute values assumed by the relations of one type. To perform the access, the application need not know the particular name of the relations or an identifier or an access path to the relations of the type. In addition, the introduction of relation types greatly facilitates filtering of certain relations because only certain relation types need be specified, for example, and all relations of these specified relation types are filtered out. This filtering facilitates retrieval of information, which in turn results in shorter computation times and facilitates the work of experts.

The automatically analyzable specifications are assigned to these relation types and not to individual relations, for example, or even types of design features. Therefore, data object types remain free of references to other data object types, which would be unavoidable if the automatically analyzable specifications were assigned to data object types. This feature is advantageous in particular when another data object type to which a first data object type refers is deleted. If the first data object type had a reference to the other data object type, then it would be necessary to ensure that this reference will be deleted when the other data object type is deleted. Through the present invention, data objects are generated and saved separately from their mutual relationships.

The system according to the present invention does not require an intermediate model which is valid for multiple phases of the product formation process. The system therefore avoids the disadvantages described above.

The great complexity due to the many different data objects for the phases is thus made manageable.

The automatically analyzable specifications are preferably formulated so that they do not depend on a certain application of the product formation process but instead are application-neutral. This allows an additional application to be added or an old one to be replaced by a new one without having to modify the data management of other applications. The specifications represent information about which calculations, analyses and generations are to be implemented. Information about how the specifications are to be executed in detail is assigned to the particular application to be executed.

Because automatically analyzable specifications are assigned to the relation types, the specifications are modifiable without having to alter the data object types. The specifications are assigned directly to the data object types to which they refer, namely relation types among data objects. This eliminates the need for formulating a complex unstructured knowledge base for many different specifications. Such a knowledge base is difficult to maintain. There is a great risk of undetected errors creeping into such a knowledge base and resulting in defective product designs or even defective products.

Another advantage of the present invention is that it is able to yield productive results even when not all data object types are linked together by relation types. Instead, the system according to the present invention is also able to work with incomplete information, e.g., with relation types for only some of the dependencies among data object types. Later supplementation makes it unnecessary to subsequently revise earlier findings. This aspect is important in particular when the product formation process is already established in a company, specific applications for individual phases are in productive use and therefore, in its introduction, the system according to the present invention is linked step by step to the existing applications used in production, because it is impossible in ongoing operation to suddenly create a combination with all these applications or even to interrupt ongoing operation for their introduction. Different degrees of coupling of different applications are implementable with the system according to the present invention. The system according to the present invention may first be used as a prototype for individual phases and applications and then be linked step by step to other applications. This scalability in particular makes is possible for the system according to the present invention to be introduced into an existing product formation process by an evolutionary procedure. The aspect mentioned above also makes it possible to adjust the present invention in the course of a product formation process instead of having to make do with a rigid data management scheme during the entire product formation process.

The introduction of relation type categories among relation types is another feature by which double and undesirably redundant data management is prevented. Information valid for m relation types T_1, . . . , T_m is assigned to a relation type category K. The information is formulated once and saved. In generating m relation types T_1, . . . , T_m, it is specified that these m types are of relation type category K. Therefore, the findings for K are valid for the m relation types. It is also possible to subsequently assign a relation type T_i to a relation type category.

In particular it is possible to define for a relation type category which attributes and methods the relation types of that category must have. Other examples of information assigned to a relation type category include the finding that each relation type of the category must have a name and an automatically analyzable specification. Processing algorithms may also be assigned to a category. A specification which limits or checks the assignment of data object types to relation types of the category may be defined for a relation type category. This specification refers to data object types, for example. It is also possible to introduce categories of data objects and to have a reference to data object categories in a specification assigned to a relation type category.

Another advantage of using relation type categories occurs when information valid for multiple relation types of the same relation type category must be modified subsequently, e.g., on the basis of a new design version, new requirements of the product to be designed and manufactured or because errors have become apparent in the old design or work plan. Because the information is stored only once, namely as part of the information about a relation type category, it needs to be modified only once. However, if it were stored multiple times redundantly, multiple revision processes would have to be performed. There is a great risk that a required change process might not be executed at all or might be executed incompletely or erroneously, thereby allowing errors to end up in the product model.

Certain relation types may be selected automatically by specifying at least one certain relation type category so that all relation types of the specified category are selected. This permits intelligent filtering of and focusing on certain relation types.

The taxonomy among relation type categories creates organization in the set of relation types, which under some circumstances may be extensive. An application may automatically determine syntactic rules and semantics for a relation type by determining the assigned relation type category and its position in the taxonomy and analyzing the information about this relation type category. The risk of different relation types being introduced for the same state of affairs is thus reduced. This avoids unnecessary redundancy and overlapping.

Preferably a uniform taxonomy is created for all data object types. This taxonomy includes multiple phases of the product formation process and data object types for different abstraction levels of the product, e.g., assemblies, components, design features and manufacturing features in a single taxonomy. In particular, the taxonomy is not limited to types of features. Therefore different phases and abstraction levels may be treated uniformly and with the same notation.

The taxonomy of relation type categories and the taxonomy of data object types, are preferably not generated for each product formation process. Instead the system according to the present invention includes two standard expandable libraries that are defined in advance and across applications, namely one library having data object types and another library having categories of relation types between these data object types. These two standard libraries are valid, for example, for each model series of an automobile manufacturer, designed and manufactured according to a product formation process that is defined once. They may be used as the starting point for a certain product formation process, e.g., a certain new model series of an automobile manufacturer and they may be expanded, e.g., for the product formation process of a certain model series or a certain application. The libraries preferably are in the form of software libraries that may be linked together from the standpoint of data technology or in the form of data records in a database. It is also possible to provide only the standard library for data object types or only the standard library for relation types.

Specific data object types and relation type categories are generated as subtypes of data object types and/or relation type categories of the standard libraries. Attributes and other information assigned to a data object type and/or a relation type category of the particular standard library are also valid for all subtypes by inheritance along the taxonomy of the data object types and/or the relation type categories—unless defined for the data object type and/or the relation type category. Definitions for a more specific data object type overwrite inherited definitions for a more abstract data object type (overloading). Specific types and categories already have approximate semantics due to their creation as subtypes and/or subcategories of types and/or categories of a cross-applications standard library and they may be analyzed by applications. For example, a specification which refers to one type or one relation of a standard library may also be applied to the specific subtype and/or subcategory because the subtype and/or subcategory has through inheritance at least all those specifications, methods, attributes, etc. that are associated with the type and/or the category from the standard library.

The taxonomy of data object types facilitates the assignment of data object types to relation types. For example, two abstract data object types, i.e., data object types that are roots of branches of the treelike taxonomy, i.e., having multiple subtypes, may be assigned to one relation type. This assignment defines the fact that a relation of the relation type may connect two data objects of two data object types of these two branches but it may not connect any data objects of other data object types. The test is performed automatically, for example, after generating a relation. The taxonomy of data object types may provide for multiple inheritance, i.e., one data object type may have other data object types as the parent or superclass and may inherit different specifications, methods, or attributes from them. The taxonomy then no longer forms a tree but instead forms a directional acyclic graph.

In addition to linking data objects by relations, automatic feature recognition and feature identification are preferably implemented. Type coding of certain components of a product model or process model that have not yet been type coded is performed by assigning them to previously defined data object types. It is preferably made possible for a component to be assigned not only to a branch of the taxonomy among data object types but instead to also be assigned to an abstract data object type. Then these data objects are linked to other data objects for other phases of the product formation process through relations.

Data object types and thus data objects are preferably assigned to certain phases of the product formation process. A data object type may be assigned to multiple phases. The phases are likewise modeled as data object types, for example, which are linked to other data object types by relation types.

The system according to the present invention preferably includes (Claim 8) a device for assigning a data object type to at least one of at least two different phases of the formation process and a device for generating a single taxonomy for data object types, . . . ) which are assigned to a first phase and for data object types (500.1, 500.2, . . . ) that are assigned to a second phase. The taxonomy may include data object types for any number of phases. This embodiment is preferably combined with a system having the features of Claim 1. However, it is also possible to provide a system for generating information about data objects, the system including
a device for generating data object types,
a device for assigning a data object type to a phase,
and a device for generating a single taxonomy for data object types.

An exemplary embodiment of the system and information model according to the present invention is described in greater detail below on the basis of the accompanying drawing.

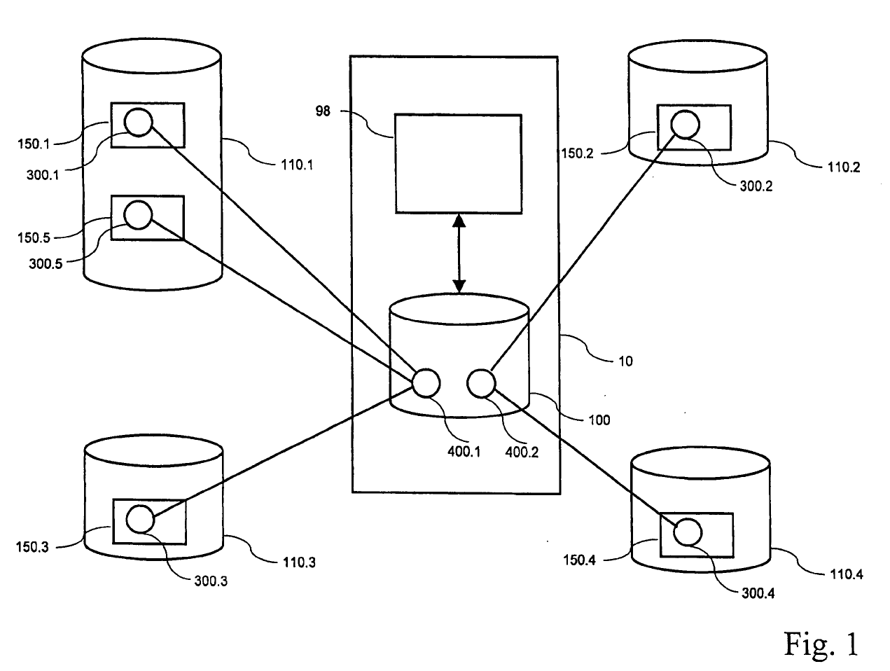

FIG. 1 shows the interaction of the system according to the present invention with a plurality of applications;

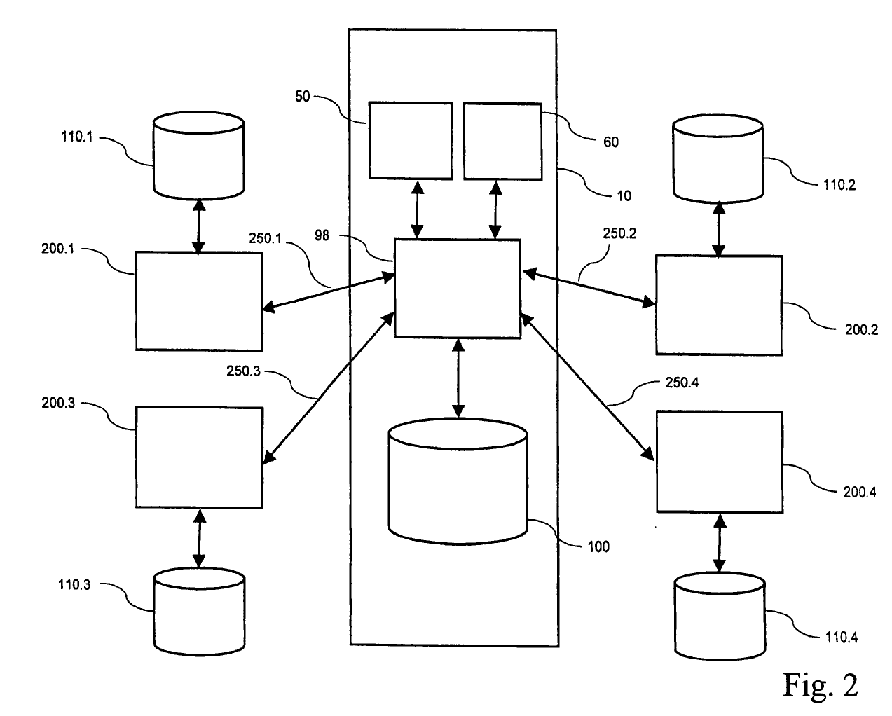

FIG. 2 shows an architecture having the system according to the present invention and a plurality of applications;

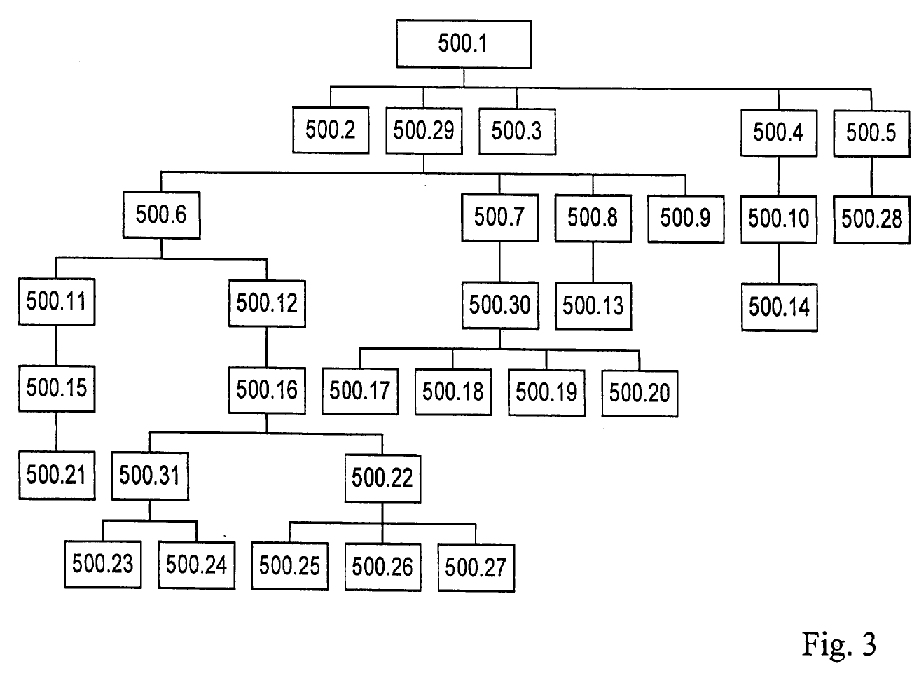

FIG. 3 shows a detail of a taxonomy of data object types.

FIG. 1 illustrates for this embodiment the interaction of the system according to the present invention with four applications 200.1, 200.2, 200.3 and 200.4. System 10 according to the present invention includes central service routine 98 and central database 100 having relation type categories, data object types and relation types as well as relations 400.1, 400.2, 400.3, 400.4. Relation type categories first, relation types 600 and data object types 500 second and relations 400, third, logically form three different abstraction levels but are preferably stored physically in the same central database 100. Information routing interfaces 250 connect central service routine 98 to four applications 200.1, 200.2, 200.3 and 200.4. The two applications 200.2 and 200.4 each manages a local data management 110.1 and 110.2 filled with data from central database 100. All four applications manage product models 150.1, 150.2, 150.3 and 150.4 having data objects 300.1, 300.2, 300.3, 300.4 and 300.5. Between three data objects 300.1, 300.2 and 300.5 in product models 150.1 and 150.3 there is in this example a relation 400.1 and between 300.2 and 300.4 in product models 150.2 and 150.4 there is a relation 400.2. Relation 400.1 thus interconnects three data models, two of which belong to the same application and a third belonging to another application. These relations are saved and managed in central database 100. Such an architecture is described in greater detail below.

The system 10 according to the present invention is implemented with the help of a central data processing system which is preferably connected to multiple other data processing devices. System 10 includes a central service routine 98 and a central database 100. System 10 according to the present invention preferably functions as a central data management system for applications 200 and thus for multiple phases of the product formation process. In this way, an application 200 for a phase is supplied with data and information from other phases and the individual applications are better integrated together. This process of being supplied with data and information prevents errors which occur, e.g., due to media failures, saves time and facilitates changes because the effects of a change in one phase on other phases or on other applications 200 are determined.

Applications 200 usually assume specific functions for certain phases of the product formation process. These phases include for example concept design, detailed design, calculations, design of the tools needed for product manufacturing, building prototypes and testing, work planning for mass production, resource planning, work planning for mass production including planning of process resources, mass production, quality control, evaluation of findings in use in mass production. Examples of applications 200 on data processing equipment include software systems for design (computer-aided design, CAD), for product data management, product engineering management, for product simulation using computation models, e.g., for the behavior of the product under mechanical loads, for manufacturing planning, for resource planning (enterprise resource management), for programming machine tools, for performing and analyzing measurements for quality assurance and for workflow management.

Each of these applications 200 uses a specific view of the product and requires certain data objects 300. Reasons for the different views include the fact that each application 200 must fulfill specific tasks and therefore requires specific data, information and knowledge and requires certain work states in problem solving. A data object 300 belongs to at least one specific model 150 which in turn belongs to a certain view of the product or the process and is generated and processed by at least one application 200 for a phase of the product formation process. It is possible for the same model to be processed by different applications 200.

These applications as well as central database 100 are connected to the central service routine via information routing interfaces 250. Preferably no interfaces are provided connecting two applications 200.a, 200.b directly to one another or an application 200 to central database 100 of system 10. This reduces development and maintenance costs: only n interfaces between the applications and central service routine 98 are required for n applications 200.1, . . . , 200.n. If direct interfaces between n applications 200.1, . . . , 200.n were necessary, then in the extreme case, a total of n*(n−1)/2 interfaces would have to be developed and maintained. For n=10, thanks to the present invention only 10 interfaces need be developed instead of 45 cases in the extreme case. In addition, no conversion between application-specific product models or process models 150 and the particular information model and/or data model used will be necessary due to the central data management.

FIG. 2 shows an exemplary architecture having system 10 according to the present invention and four applications 200.1, 200.2, 200.3 and 200.4. The four applications are connected to central service routine 98 via four information routing interfaces 250.1, 250.2, 250.3 and 250.4. No direct interfaces between two applications 200.1, 200.b or an interface between a local data management 100.x and central database 100 are necessary. In addition, system 10 includes a user surface 50.

The central data management is preferably written to and read out exclusively by central service routine 98. Only central service routine 98 but not applications 200.1, 200.2, 200.3 and 200.4 have read and write access to central database 100. The following information is managed permanently in central database 100 and made available to the applications via central service routine 98 and information routing interfaces 250:
relation type categories and the taxonomy therefor,
data object types 500 and the taxonomy therefor,
relation types including the taxonomy therefor and the automatically analyzable specifications,
and relations 400 and references therefrom to the particular relation types.

After a read access, an application 200.1 thus “knows” relations, e.g., a relation 400.1 between a data object 300.1 of a model 150.1 generated by application 200.1 and another data object 300.3 of a model 150.3 generated by another application 200.3. However preferably no information about the other models is stored in models 150 or local data memories 110 so that a model of an application does not have direct references to a model of another application.

Data objects 300 and applications 200 for generating, processing and analyzing data objects, in particular design features and manufacturing features are often tailored to the specific requirements of the phase. They represent the components of the product or process that are relevant for the particular phase. Data objects 300 and relations 400 form the building blocks for generating models 150 for the particular phase. A data object 300 is preferably generated, modified, deleted and managed not by central service routine 98 but instead by the particular application 200. Application 150 ensures in particular permanent storage of data object 300, e.g., in a local database 110. Data object 300 is a component of a product model or process model 150 and is usually available only to generating application 200 but not to any other application.

Central service routine 98 is able to address a data object 300 via an access process, e.g., with the help of an access path to product model or process model 150 and an identifier which is unambiguous within this model or to an application 200 via an application programming interface (API) to an application 200. A relation 400.1 stored in central database 100 has references to data objects 300.1 and 300.3 which are linked by relation 400.1. These references include all information needed for read access to data objects 300.1 and 300.3.

An application 200 is able to trigger generation and permanent (persistent) storage of a data object type 500 in central database 100 via an information routing interface 250 and central service routine 98. Conversely, application 200 is able to acquire information about data object types 500 from central database 100, e.g., to generate a data object 300 of a certain data object type 500 by instantiation. For example, the instruction to generate by instantiation a data object 300 of a specified data object type 500 via an information routing interface 250 to a CAD tool. System 10 according to the present invention specifies, to application 200, type 500 and the name and specific attributes and/or methods of data object 300 to be generated.

Before an application 200.1 deletes a data object 300.1 generated and managed by it, central service routine 98 determines which data objects 300.3 of the same or other applications will be affected by this deletion. The following sequence is automatically executed here (see FIG. 1):
Application 200.1 transmits to central service routine 98 an identifier and the type 500.1 of data object 300.1 to be deleted.
Via read access to central database 100, central service routine 98 determines through which relation types data object type 500.1 is connected to other data object types.
Let 600.1, . . . , 600.n be these types.
Central service routine 98 determines m relations 400.1, . . . , 440.m which are of one of types 600.1, . . . , 600.n or of a subtype of these n types and each of which carries a reference to data object 300.1,
Central service routine 98 determines which other data objects 300.3, 300.5 are assigned to at least one of these m relations. These data objects will be affected by the planned deletion.
Central service routine 98 determines which automatically analyzable specifications are assigned to n relation types 600.1, . . . , 600.n. By analyzing these specifications, central service routine 98 determines additional consequences of the planned deletion, e.g., changes in parameters or deletion of other data objects.
Central service routine 98 determines which applications 200.1, 200.3 manage at least one of these other data objects 300.3, 300.5 affected and transmits a description of the effects to the particular application 200.1, 200.3.
For example, by processing a workflow, the deletion of 300.1 is enabled as required.
After deletion, central service routine 98 deletes all references to deleted data object 300.1 from relations 400.1, . . . , 400.m. Relations are deleted as needed.

According to an alternative embodiment, application 200.1 deletes data object 300.1 and only later routes the information about the deletion to central service routine 98.

An appropriate sequence is executed, e.g., to generate information about which additional data objects a previously selected type-coded first data object 300 is connected to. This information is generated either by direct analysis of information or by the following sequence, for example:
A type-coded data object is selected.
The data object type of this data object is determined.
All relation types to which this data object type is assigned are determined.
All other data object types which are assigned to one of these relation types are determined.
All data objects of these types are determined.

System 10 according to the present invention includes components for performing these determinations.

Central service routine 98 regulates the flow of control and information among applications 200 and between an application 200 and central database 100. It answers inquiries arriving from an application 200 via an information routing interface 250, triggers events such as the generation of a data object 300 and manages central database 100 including transaction management for permanent storage of data objects 300 and relation types 600, relations 400 and relation type categories.

Central service routine 98 accesses a relational database which functions as central database 100, e.g., with the help of standard protocols such as “Open Database Connectivity” (ODBC). The “Standard Query Language” (SQL), for example, is used as the standard language for querying relational databases. According to an alternative embodiment, functional or object-oriented interfaces in conjunction with defined application programming interfaces (APIs) are provided between central service routine 98 and central database 100. Central service routine 98 uses functionalities of programming interfaces to obtain reading and/or write access to central database 100. An advantage of XML data files is their ease of handling. ODBC and SQL are widely used standards. Many software development environments have ODBC and SQL interfaces. One advantage of programming interfaces is that the type of data storage is not visible to the outside and therefore central database 100 may be modified internally without having to modify central service routine 98 or even applications 200. Applications and central service routine 98 are preferably interconnected by interprocess communication, e.g., on the basis of “distributed component object model” (DCOM), “Hypertext Transfer Protocol” (HTTP) or “Common Object Request Broker Architecture” (CORBA) with “Interface Definition Language” (IDL) or “Enterprise Java Beans” (EJB).

It is possible for central service routine 98 and additional components of system 10 according to the present invention and at least some applications 200 to all run on the same data processing system. However, system 10 according to the present invention preferably includes its own data processing system which functions as a network central computer (server) in a client-server architecture. The data processing devices for applications 200 function as network clients.

The present invention supports the integration of different applications 200 in two directions along the product formation process: downstream (forward) and upstream (backward). Integration upstream is achieved in particular by determining the effects of a change in one phase on subsequent phases, e.g., from the design phase to the fabrication phase or to the tool building phase during which, depending on product models 150, the tools needed for manufacturing the product are designed. Integration downstream results in applications 200 in later phases being informed of models 150 in earlier phases. Individual data objects 300 of these earlier phases, e.g., the product design phase, may be assigned to design rationales, for example, resulting in better decisions in subsequent phases.

The present invention supports, through integration, e.g., cost estimation, product design with a predetermined optimization criterion or predetermined boundary conditions (design-to-X), workflow management and handling of findings, justifications, and rationales.

For cost estimation, it is necessary to determine in particular the cost of manufacturing the design features of the product. If the cost is too high, individual design features must be modified to lower the total manufacturing cost. These design features include, for example, certain holes in cylinder heads. A data object type “holes in cylinder head” for the product design phase and at least one data object type for manufacturing features for producing the holes are introduced and interlinked by a relation type “is produced by.” The manufacturing features belong to a product model 150 for work and manufacturing planning (machining planning). They are linked to an application 200 for cost estimation, e.g., including a database 110 having data records for tools, machining times and hourly rates. Thanks to the present invention, application 200 which processes product model 150 using the design features has read access to the cost information and is able to cause the cost of manufacturing the whole to be predicted.

Supply and integration are implemented according to the present invention via two features. Data object types for different phases are linked semantically by being combined in a single taxonomy. This ensures a joint notation, e.g., of types and attributes for all phases, while avoiding redundancy and double data management. It is not necessary to generate and analyze transformations between models for different phases. As described above, eliminating transformations saves a number of interfaces in particular.

FIG. 3 shows a detail of the cross-applications and cross-phases taxonomy for data object types. A rectangle represents a data object type. An edge connects a subtype to the parent type shown above the subtype. The rectangles represent the following data object types:

| Reference | |
|---|---|
| Numeral | Name of Data Object Type |
| 500.1 | more abstract type “data object types” |
| | (engineering object types) |
| 500.2 | user interface features |
| 500.3 | xyz features of a CAD tool used for production |
| 500.29 | features |
| 500.4 | parts of the product |
| 500.5 | quality features |
| 500.6 | design features, finished part features |
| 500.7 | manufacturing features |
| 500.8 | raw part features |
| 500.9 | inspection features |
| 500.10 | parts required for a mold (mold parts) |
| 500.28 | measurement features (measure elements) |
| 500.11 | sheet metals |
| 500.12 | volumetric features |
| 500.30 | machining features |
| 500.13 | raw part cylinders |
| 500.14 | ejectors |
| 500.15 | subtractive features |
| 500.16 | holes |
| 500.17 | machining cylinders |
| 500.18 | threads |
| 500.19 | tapers |
| 500.20 | chamfers |
| 500.21 | slots |
| 500.31 | simple holes |
| 500.22 | complex holes |
| 500.23 | blind holes |
| 500.24 | through holes |
| 500.25 | debored blind holes |
| 500.26 | debored through holes |
| 500.27 | spark plug holes |

All types of features known from DIN 32869-3 in particular may be classified in this taxonomy.

Data objects, in particular design features and manufacturing features, are preferably handled according to the object-oriented paradigms such as that known from J. Rumbaugh, M. Blaha, W. Premerlani, F. Eddy, W. Lorenson: “Object-Oriented Modeling and Design,” Prentice-Hall, Englewood Cliffs, 1991. Data objects 300 are type-coded and types 500 (types/classes) of data objects may have attributes or parameters that describe the static properties of the data objects and may have methods for the dynamic properties of the data objects.

A data object 300 of a specified data object type 500 is generatable by “instantiation” of the data object type. The data object so generated has the attributes and methods of the data object type. To reduce redundancy among data object types, preferably multiple abstraction steps are performed. Commonalities among n data object types 500.1, . . . , 500.n are identified and combined in a new more abstract data object type. This new data object type 500.o is the parent of 500.1, . . . , 500.n; 500.o is connected to 500.1, . . . , 500.n by a specialization relation. The result of the abstraction steps is a taxonomy of data object types 500. Branches of this taxonomy, i.e., data object types without subtypes may be instantiated but preferably not the more abstract data object types.

Appropriate type coding is performed for relations 400 according to the present invention among data objects 300. This results in relation types 600 from which relations 400 may be generated by instantiation. Through appropriate abstractions of relation types 600, relation type categories and a taxonomy of these relation type categories are generated.

A relation 400 connects at least two data objects 300.a and 300.b. A relation 400 functions as the building block for management and analysis of the dependencies among data objects 300.a, 300.b. A relation 400.a may also connect another relation 400.b to one or more data objects 300.a, 300.b or may connect multiple other relations to one another. Accordingly, a relation type 600 interconnects at least two data object types 500.a and 500.b. One relation type 600.a may also connect another relation type 600.b to one or more data object types 500 or may interconnect multiple other relation types.

An example of a relation interconnecting other relations would be data objects and relations for a hole pattern, i.e., multiple holes having certain positions in relation to one another, punched out of sheet metal. A “hole” data object type having the two subtypes “reference holes” and “dependent holes” is introduced. The n holes of a hole pattern are represented by a data object of the “reference hole” type and n−1 data objects of the “dependent hole” type. The absolute target position of the reference hole and the relative positions of the n−1 dependent holes are specified and are represented by corresponding attributes. In addition, a data object of the “position tolerance” type and n−1 data objects of the “measurement tolerance” type are generated and assigned to the reference hole and/or the n−1 dependent holes via relations.

A “relative position” relation type and n−1 relations of this type are generated. Each relation of this type interconnects the reference hole, a dependent hole and a measurement tolerance. The “relative position” relation type is connected to the “reference hole,” “dependent hole” and “measurement tolerance” types of data objects. It includes a checking specification for the relative position of the dependent hole in relation to the reference hole of the hole pattern. The specification refers to the measurement tolerance specified by the third data object. Each relation of the “relative position” type “is aware” of this specification. In analyzing the relation, system 10 according to the present invention determines the required attributes of the three data objects and inserts them into the specification. A check is performed by the analysis of the specification to determine whether the relative position is in compliance with the stipulated measurement tolerance. Another relation type known as “hole patterns” is introduced. A relation of this type is generated for each hole pattern, interconnecting the n−1 relations of the “relative position” type just described. Central service routine 98 is able to access all data objects and relations representing the hole pattern via this relation.

According to a different embodiment of this example, N subtypes of the “dependent hole” data object type are to be generated, where N stands for the maximum possible number of holes of a hole pattern. The n−1 data objects for the n−1dependent holes of the hole pattern belong to n−1 different types of the N data object types. Thanks to this embodiment, it is possible to address a certain dependent hole with a knowledge of just the particular data object type.

Special cases of data object types include the “commentary” type, the “user help” type, the “empirical objects” type and “documentation” type. An empirical object includes text, images and/or image sequences which describe experience with another data object or a relation or rationale, e.g., for a design decision (design rationale). For all these types, the “explanations” parent type is introduced. A data object of the “explanations” type is connected by a relation to at least one other data object, e.g., a feature or a component, a data object type or a relation or a relation type or a relation type category. The same explanation may be assigned to different data objects. It is possible to assign an explanation first to a data object and later after an enable process to the corresponding data object type. The relations between explanations and other data objects, relations, types or relation type categories are also type-coded, e.g., they all belong to an “explanation assignment” relation type.

Depending on the automatically analyzable specifications, two types of relations are differentiated, namely checking relations and generic relations. Accordingly, a distinction is made between checking and generic relation types.

A checking relation type describes at least one logic dependency between data objects through the associated checking specifications. A check is performed to determine whether the existing data objects are consistent with the specifications. New data objects are not generated. A special form of a checking specification is an attribute of the relation type. This attribute characterizes, for example, a relation and thus a dependency between data objects of different applications 200.1, 200.2.

An example: a cylinder head includes n cooling ribs. These are modeled by n design features in the design phase. A basic body for the cylinder head is supplemented by these n design features. In the manufacture of the cylinder head, the cooling ribs are produced by cutting recesses out of a block. These recesses to be cut out are modeled by manufacturing features in the work planning phase. To determine dependencies among these features, a type of relations between n design features for the design phase and m manufacturing features for the work planning phase is introduced. Such a relation links n cooling ribs and m grooves on a cylinder head.

To determine how many data objects this relation links, two membership intervals (cardinalities) for the relation type are defined. The first membership interval limits the number of cooling ribs while the second limits the number of grooves cut. A membership interval is in the form a:b, for example, where a is a natural number and b is a natural number or *. The statement * stands for any number of data objects.

Preferably also two external roles are assigned to the relation type, namely roles “as design features” and “as manufacturing features.” This determines which roles the linked data objects play in a relation of the type “from the viewpoint of the role.” In the general case, preferably n membership intervals and n roles are defined for one relation type, linking n data object types and/or relation types together. This embodiment makes it possible to efficiently model m:n relations.

Furthermore, a symbol of its own role is assigned to a relation type, i.e., the role played a relation of that type from the standpoint of the connected data objects. The difference between external roles and one's own role is illustrated by the following example:

Two data object types: “design features” and “manufacturing features” are generated. The “design features” data object type has the subtype “two-step holes,” while the data object type “manufacturing features” has the subtype “holes.” “Two-step holes” and “holes” are assigned to a “manufactured as” relation type so that a relation of this type connects a two-step hole to two holes. Its own roles “manufacturing viewpoint” (from the viewpoint of the design features) and “manufactured part view” (from the standpoint of the manufacturing features) are assigned to the relation type. In addition, the “upper hole” and “lower hole” external roles (from the standpoint of the two-step hole) and “step hole” (from the standpoint of the holes) are assigned to the relation type.

The specification assigned to the relation type known as “manufactured by” defines, for example, which and how many manufacturing features are necessary for given design features. The checking specification states, for example, that m=n−1 must hold. It may refer to the two membership intervals. For example, if ten design features, but only five manufacturing features have been generated, then a contradiction is discovered and reported by applying this specification.

The missing manufacturing features are not generated automatically. It is the responsibility of the particular application 200 to which the contradiction is reported or its user to correct this.

Checking relations may also have what is known as ontological knowledge of semantic relationships between data object types. They allow a consistent flow of information along the product formation process and link applications on the information level rather than only on the data level.

A generating relation includes at least one automatically analyzable generation specification which defines how data objects are generated automatically. This specification is assigned to a type of generating relations and defines the desired result of a generation step. Central service routine 98 preferably transmits this desired result to particular applications 200. It is the responsibility of these applications 200 and, if necessary, their users to generate the desired result.

These specifications may depend on conditions in product models 150 or may be triggered by these events or other defined events. For example, after each change in an application-specific model for one phase, a determination is made as to which objects are influenced by the change and which generating relations are based on these data objects. A change in the product model triggers an automatic analysis of the generating relations determined on the basis of the change. Generating relations thus automate tasks of the product formation process.

A generating relation preferably links the data objects which trigger a generation step to those data objects which are generated in this generation step, e.g., by “instantiation.” The generation specification assigned to the particular type of generating relations includes all information necessary to instantiate objects in a certain product model or process model.

A specification included by a generating relation in turn generates, for example, a group of features interconnected by relations (feature constellation). Not only are the data object types instantiated to generate the interconnected features but also the relation types are instantiated to generate the connecting relations. For example, a generation step is always triggered when a data object specified in advance is altered or instantiated. The finding whereby a generation step is triggered is assigned according to this invention to one relation type. A specification which is assigned to one relation type is interpreted, for example, by a component of system 10 according to the present invention. Or central service routine 98 routes the specification to an inference machine 60 which performs the automatic analysis and returns its result, i.e., the desired result of a generation, back to central service routine 98. Since inference machine 60 performs complex analyses, it is often advantageous to implement it as a separate application separately from central service routine 98.

Use of relation type categories, relation types and relations will now be explained using an example. For a product formation process of an automobile manufacturer which is valid for each of the manufacturer's new model series, a data object type “holes” is introduced in the standard cross-applications library and this data object type is assigned to the product design phase. The data objects of this type are design features. In addition, a type of quality feature known as “function tolerances” is introduced with the subtypes “shape tolerances,” “position tolerances” and “measurement tolerances” and assigned to the “design” phase. The “holes” type has a subtype “boreholes” which has its own subtypes “boreholes for automobile body.” This embodiment takes into account the fact that design engineers define the functional tolerances, e.g., for design features, in the “design” phase. In the “production planning” phase, additional tolerances are defined, e.g., those for monitoring the manufacturing process and in particular the machining equipment and tools used to manufacture the product.

A type of measuring features known as “measuring points” is assigned to the quality assurance phase. Each measuring feature represents a sampling point whose actual position and/or orientation is determined during quality assurance and is compared with a setpoint position and/or setpoint orientation.

Three categories of data objects are generated: namely the category of design features, the category of quality features and the category of measuring features. A relation type category known as “measurement strategies” is introduced. The following are defined:
that a relation type of this category links three data object types, namely a type of design elements, a type of quality features, and a type of measuring features,
and which parameters must at least have a relation type of the category, preferably at least a name and a measurement strategy, formulated with the help of the document writing language “extended Markup Language” (XML), for example, or as free text.

Each relation type of the “measurement strategies” category thus links a type of design features, a type of quality features, and a type of measurement features.

A checking relation type of the “measurement strategies” category is generated and provided with the name “checked by” and assigned to the “measurement strategies” category. The relation type “checked by” interconnects three data object types, namely the “boreholes” types, the “hole tolerance” type, and the “measuring points” types. For example the following checking specification is assigned to this relation type:

The following holds for each design feature k, each quality feature qu and each measuring feature m:

If the type of k is equal to “boreholes for automobile body,” then it holds that:

If the diameter of k is smaller than 0.5 mm and the tolerance of qu is greater than 0.1 mm, then the number of m is equal to 5.

If the diameter of k is less than 0.5 mm and the tolerance of qu is equal to or smaller than 0.1 mm, then the number of m is equal to 8.

If the diameter of k is between 0.5 mm and 5 mm, then the number of m is equal to 10.

If the diameter of k is greater than 5 mm, then the number of m is equal to 20.

The “number of m” refers to the number of measuring points which are assigned to the borehole and with which it is possible to check on whether the required tolerance is met.

In addition, this invention permits a “bidirectional associativity” between data object types. This is illustrated by the following example. Two data object types A and B have three parameters x and y (parameters of A) and z (parameter of B). An automatically analyzable checking specification stipulates that B.z=A.x*A.y. If two of these three parameters are known, the third is calculated automatically. If upper and/or lower limits are known for two parameters, an upper and/or lower limit for the third parameter may be set. In generating the specification, it is not necessary to know which are the known parameters and which are the unknown parameters. Tools for automatic equation and inequality solving (constraint solvers) instead permit such an equation to be solved automatically for the unknown. Such tools are described in WO 00/31640 A2 and U.S. Pat. No. 5,477,450, for example.

According to the present invention, specification B.z=A.x*A.y is assigned to a relation type R to which data object types A and B are also assigned. If an application 200 has generated a data object b of type B and the value for b.z is to be determined, then it is determined by which relation b is connected to other data objects and a relation r of type R is hereby determined. By read access to R, specification B.z=A.x*A.y is determined and automatically analyzed. The procedure is similar when a data object a of type A has been generated and the value for a.x is to be determined.

However, if specification B.z=A.x*A.y were assigned to data object type B, then when the value for a.x is to be determined, it would be necessary to search through all data object types to find data object type B and a usable specification there. Under some circumstances, even other applications 200 would have to be consulted for this.

System 10 according to the present invention automates cooperation among various applications 200 and thus the automation of functions of the product formation process via different phases and applications 200. For example, an application 200.1 transmits to central service routine 98 the fact that application 200.1 will generate a data object 300.1 of a specified type by instantiation. This data object 300.1 belongs to a product model 150.1 that is generated and processed by application 200.1. Central service routine 98 specifies type 500.1 of data object 300.1 to be generated and determines which relation types link this data object type 500.1 to other data object types. If there are no such relation types or if exclusively checking specifications are assigned to this relation type, then system 10 sends a message to application 200.1 that generation of data object 300.1 may be continued. If necessary, it transmits names and attribute values for data object 300.1 to application 200.1. However, if a relation type is determined using a generating specification, inference machine 60 will analyze it. The result depends on data object 300.1 of type 500.l to be generated, e.g., it includes the fact that n data objects of a type 500.2 and r data objects of another type 500.3 as well as relations among new data object of type 500.1, n new data objects of 500.2 and/or r new data objects of type 500.3 are to be generated. Inference machine 60 transmits this result to central service routine 98. Central service routine 98 determines which applications 200 are influenced by this result, e.g., triggering application 200.1 and/or other applications. Each application 200.b thus influenced receives the message of which data objects it is to generate, e.g., which n of type 500.2 and which r of type 500.3. Generation of these data objects is the responsibility of the particular applications. After applications 200 have completely generated data objects 300 for their particular product models 150, they send a message back to central service routine 98 that the proposed generations have been executed.

A similar sequence is triggered when an application 200 changes or deletes an existing data object 300 (change management). When a relation type 600 is determined using a checking specification, it is used to check on whether a consistent state still prevails after the change or whether the change violates an automatically executable specification assigned to a relation type.

In addition, system 10 according to the present invention supports simultaneous cooperation of various applications 200 (concurrent engineering). Changes performed by a first application 200.1 on a first model 150.1 of the product or process often have effects on a second model being processed by a second application 200.2. However, if first application 200.1 does not have write access to second model 150.2 because the processing of the second model is the responsibility of the user of second application 200.2. In this case, system 10 determines which data objects of first model 150.1 are affected by the change. It ascertains which relations link this data object to other data objects and which specifications are assigned to types of these relations. By analysis of these specifications, it is possible to determine which additional data objects already in existence must be changed and which new data objects must be generated, so that the second model and the first model are mutually consistent even after the change. The information generated in this way is sent as suggestions to second application 200.2. Whether or not these proposals are implemented and if so, how, are the responsibility of the user of the second application.

To save data object types 500 and relation types 600, a procedure and a data model that are independent of a certain application are preferably selected. According to one embodiment, “eXtended Markup Language” (XML) syntax is to be used with “XML Scheme Definition” (XSD) and information is to be saved as ASCII text or text in Unicode format. For example, information about data object types 500 and relation types 600 is saved in different data files and/or tables of a relational database. Each type is saved as its own XML entity in its own data record of a table. Applications 200 have read and write access to central database 100 of system 10 according to the present invention as central data management via defined information routing interfaces 250. Standards such as “Open Database Connectivity” (ODBC) are preferably used for this for linking to relational databases, and the “Standard Query Language” (SQL) is used as the standard language for queries of relational databases. This embodiment makes it possible to use any SQL- and ODBC-capable relational or object-oriented database and to replace one database with another database as needed later without having to input data again and without central service routine 98 having to change an application.

Data objects 300 are preferably saved together with particular product model 150, whereas relations are saved separately from applications 200 in central database 100 together with the types. User interface 50 of system 10 according to the present invention is preferably implemented separately from central service routine 98. User interface 50 may thus be tailored to different users and “personalized” without having to adapt the data management to different user groups. For example, more possible actions are made available to an experienced user, whereas a new user will receive more help items.

Central service routine 98 also preferably generates and manages models for read and write corrections, the behavior, capabilities, and preferences of users who use at least one of applications 200 (user modeling). These “user profiles” are managed in central database 100. The users are categorized in different classes, for example. Applications 200 have read access to these profiles and generate local user interfaces of the applications, which are tailored to the particular user. Since these profiles and corrections are stored and managed centrally for the users, they need only be generated and maintained once. It is not necessary for each application 200 to manage such profiles separately. This would necessarily be associated with double data management and a considerably greater expense.

A user profile preferably also includes information defining how the data object types are presented to the particular user. In addition to findings regarding the form of presentation, there is a definition of the order in which data object types occur in a navigation tree presented to the user. This navigation tree may correspond to the taxonomy but it may also have a different structure and may not show all abstract data object types (types with subtypes), e.g., only the instantiable data object types. The navigation tree for a certain user is constructed so that the user reaches certain data object types via a few operations (e.g., “opening” and selecting). The user is able to reach certain data object types used frequently by him/her more rapidly than other data object types.

System 10 according to the present invention has a user interface 50 which is preferably concealed from the users of applications 200 and is used by an operator and administrator of central database 100 and central service routine 98.

The two syntaxes for two exemplary data models are outlined below. The first data model, hereinafter referred to as the class model, defines how resource categories, resource types and data object types are saved in central database 100. The second data model, referred to below as the instance model, defines how resources (instances) are saved in central database 100. The syntax of the instance model may also be used for saving data objects. The definitions for both data models may be implemented with the help of XML and XSD, for example.

The syntax for the class model stipulates the following:
At the highest level, the class model includes at least one class and, if needed, a determination of which version of the class model is used. The class model may include any number of classes.
The following information is stipulated for a class:
   whether the class is a resource category, a resource type or a data object type,
   an internal identifier and at least one name of the class that is visible to the outside—preferably one name is stored per natural language used,
   which simple parameters the class has; a class may have one or many simple parameters or none at all; an internal identifier and at least one name that is visible to the outside, the unit of measure (e.g., mm), an elementary data type (e.g., integer), a preset value (default value), access information, a value range and explanations are stored for each parameter;
   which complex parameters the class has; a class may have one or more complex parameters or none at all; a complex parameter refers to a type of complex parameter which is a user-defined data type and includes internal identifier, name and preset values;
   which methods the class has; a class may have one or more methods or none at all; each method is identified by an internal identifier, name, list of arguments (including the argument name and data type), type of return value (return type) and method body,
   which dependencies the class has; the dependencies are formulated as automatically analyzable specifications,
   administrative information, e.g., findings as to who has read access to the class and who has write access, who created the class and when, who made the most recent changes, which applications 200 have had read access to the class.
   If the class is a relation type: a reference to the respective relation type category;
   If the class is a relation type: the partners assigned to the relation type (data object types and/or other relation types);
   external references to UDF data files, i.e., data files having user-defined design features for a certain CAD tool saved in a data format specific for that tool.
The findings regarding the partners assigned to the relation type preferably have the following structure:
   How many partners are data object types and how many are other relation types?
   the internal identifiers of the partners,
   the direction in which each partner is involved in the relation (e.g., input, output or directionless),
   the external roles played by the partners with respect to the relation,
   the relation's roles played by the relation with respect to the partners,
   and the membership intervals (cardinalities) of the partners.

An automatically analyzable specification may be implemented as a parameter or as a method of a relation type or a relation type category.

The syntax for the instance model stipulates the following:
At the highest level, the instance model includes at least one instance, i.e., a relation or a data object; in addition, if necessary, it includes a finding as to which version of the instance model is used. The instance model may include any number of instances.
The following information is defined for an instance:
   whether the instance is a relation or a data object,
   a reference to the relation type and/or data object type to which the instance belongs, namely preferably by stating the internal identifier of the type,
   an internal identifier and at least one name of the instance visible to the outside—preferably one name is saved per natural language used,
   which simple parameters the instance has,
   which complex parameters the instance has,
   management information,
   the roles played by the partners who are involved, preferably implemented as vectors with individual roles and references to the partner instances, and
   the membership intervals for the partners involved.

For example, a data record is created for each data object type 500 according to the class model. For a relation type 600.1 connecting n other types, n+1 data records are created, namely one for relation type 600.1 itself and one each for a reference to a partner, i.e., a data object 500.a or to another relation type 600.a, which is assigned to relation type 600.1 and is linked by 600.1 to other types.

The relational database is preferably structured in the normal form so that each table implements 1:1 and 1:n links but no m:n links with m>1 and n>1. The internal identifiers of the types function as keys of the data records. The XML instructions for representation of the parameters and methods of a type are entered as text into a single cell in the data record. An XML instruction for a reference to another type is also entered into a single cell. This embodiment has the advantage that information may be entered rapidly from central database 100 and the database scheme need not be altered when there is a change in a data model, e.g., the class model implemented via the “XML scheme definition” (XSD).

When the relation type categories, relation types, and data object types are entered from central database 100, the links between categories and types are kept available in the form of double pointer lists in the main memory (random access memory) of the data processing system. Central service routine 98 generates these lists in the main memory. If an application 200 needs information about a category or a type, e.g., the taxonomy of relation types categories, then no new read access to central database 100 is necessary. Instead the required information is acquired with the help of references (pointers) to certain memory cells of the main memory (random access memory). This embodiment saves on computation time because access to permanent memory media requires more time than access to a temporary storage medium such as a main memory.

1-17. (canceled)

18: A system for generating information about data objects, wherein each data object represents one of a component of a technical product and a step in a product formation process, the system comprising:
a device configured to generate data object types for the data objects;
a device configured to generate automatically analyzable specifications, wherein an analysis of the specification determines a first set of type-coded data objects as a function of a second set of type-coded data objects;
a device configured to generate relation types between the data objects;
a device configured to assign the data object types to each of the relation types; and
a device configured to assign the automatically analyzable specifications to the relation types.

19: The system as recited in claim 18, wherein the determining of the first set of type-coded data includes one of generating and modifying.

20: The system as recited in claim 18, further comprising:
a device configured to generate categories of the relation types;
a device configured to generate a taxonomy of the categories, and wherein the device configured to generate the relation types generates a respective category belonging to the relation type with the relation type.

21: The system as recited in claim 20, further comprising:
a first information memory having a first expandable cross-applications library configured to store the data object types and the relation types;
a second information memory having a second expandable cross-applications library configured to store the relation type categories; and
a device configured to generate a sub-relation type category as a subcategory of one the relation type categories in the second standard library.

22: The system as recited in claim 20, further comprising:
a first data memory configured to store the relation type categories;
a second data memory configured to store the data object types and the relation types; and
a third data memory configured to store type coded relations.

23: The system as recited claim 22, further comprising a relational database for the first, second and third data memories including a plurality of data records, wherein each data record includes a cell for an unambiguous identifier and at least one cell structured in XML data format for one of a relation type category, a data object type, a relation type and a relation.

24: The system as recited claim 18, further comprising a device configured to assign one of the relation types to another of the relation types.

25: The system as recited claim 18, further comprising a device configured to generate a specified relation of a specified relation type.

26: A system for generating information about data objects, wherein each data object represents a step in a product formation process having a first phase and a second phase, the system comprising:
a device configured to generate data object types for the data objects;
a device configured to generate automatically analyzable specifications, wherein an analysis of the specification determines a first set of type-coded data objects as a function of a second set of type-coded data objects;
a device configured to assign one of the data object types to at least one of the first and second phases;
a device configured to generate a single taxonomy for data object types assigned to the first phase and for data object types assigned to the second phase.

27: The system as recited in claim 26, wherein the device configured to assign data object types permits an assignment of at least two of the following object types to a relation type:
tapes of design features,
types of components,
types of assemblies,
types of manufacturing features,
types of quality features,
types of measurement features,
types of test features,
types of materials,
types of manufacturing equipment,
types of production facilities, and
types of commentaries.

28: The system as recited in claim 18, wherein further comprising an information routing interface to a data processing system for generating and processing a model of one of the following:
a product or part of the product,
a manufacturing process for manufacturing the product or a part of the manufacturing process,
a work flow or part of a work flow, and
a cost of manufacturing the product.

29: The system as recited in claim 28, wherein the information routing interface is configured to transmit the type and an identifier of the data object to be generated by the data processing system.

30: The system as recited in claim 29, wherein the information routing interface is configured to transmit a method and an attribute values corresponding to the data object.

31: The method as recited in claim 29, further comprising a device for generating a user profile of a user including at least one definition, wherein the information routing interface is configured to transmit the at least one definition, and wherein at least one definition includes at least one of the following:
a read and write authorization for the user,
a capability of the user in generating and processing data objects, and
a user preferences in generating and processing data objects.

32: An information model for data objects, wherein each data object represents a step in a product formation process having at least a first phase and a second phase, the information model comprising:
data object types of the data objects;
relation types of relations among the data objects;
an automatically analyzable specification, wherein an analysis of the specification determines a first set of type-coded data objects as a function of a second set of type-coded data objects, and wherein the automatically analyzable specification is assignable to a relation type and wherein, at least one of the following is assigned to a relation type:
at least two data object types;
at least one data object type and at least one other relation type; and
at least two other relation types.

33: The information model as recited in 32, further comprising categories of relation types and a taxonomy of relation type categories, wherein a relation type is assignable to a relation type category.

34: The information model as recited in 32, wherein one of a membership interval and a role is assigned to at least one relation type, wherein the membership interval or role corresponds to a link between one of the data objects and the relations to the relation type.

35: The information model as recited in 32, further comprising phase data objects, each representing one of the at least fist and second phases of the formation process, wherein one of the phase data objects is assignable to one of the data object types.

36: The information model as recited in 32, further comprising a data model for permanent storage of at least one of the data object types and the relation types structured according to the information model.
